(19) United States
(12) Patent Application Publication
(10) Pub. No.: US 2002/0158519 A1
(43) Pub. Date: Oct. 31, 2002

(54) Multiple coil pull-in coil for a solenoid assembly for a starter motor assembly

(75) Inventors: David A. Fulton, Anderson, IN (US); James D. Stuber, Fishers, IN (US)

Correspondence Address: FINNEGAN, HENDERSON, FARABOW, GARRETT &, DUNNER LLP, 1300 I STREET, NW, WASHINGTON, DC, 20005, US

(73) Assignee: Delco Remy America, Inc.

(21) Appl. No.: 09/804,183

(22) Filed: Mar. 13, 2001

(51) Int. Cl. H02K 41/00

(52) U.S. Cl. 310/14

(57) ABSTRACT

A starter motor assembly is provided having a solenoid assembly that includes a pull-in coil that is comprised of a plurality of coils connected in parallel. The plurality of coils may comprise three coils that are formed from a single wire cut and connected to form the pull-in coil. Also provided is a method of making a pull-in coil for a solenoid assembly for a starter motor assembly. The method includes the step of winding a wire down a length of a solenoid coil holder and then back up the length of the solenoid coil holder a plurality of times. Then, the wire is cut at points to form separate coils, each coil then having a first lead and a second lead opposite the first lead. The first leads of the coils are electrically connected together and the second leads of the coils are electrically connected together to form the pull-in coil comprised of multiple coils.

### FIELD OF THE INVENTION

The invention relates to a starter motor assembly for starting an engine and, more particularly, to a starter motor assembly for starting a vehicle engine that has a solenoid assembly including a pull-in coil comprised of multiple coils connected in parallel.

### BACKGROUND OF THE INVENTION

Starter motor assemblies to assist in starting engines, such as engines in vehicles, are well known. The conventional starter motor assembly broadly includes an electrical motor and a drive mechanism. The electrical motor is energized by a battery upon the closing of an ignition switch. The drive mechanism transmits the torque of the electric motor through various components to a flywheel gear of the engine, thereby cranking the engine until the engine starts.

In greater detail, the closing of the ignition switch (typically by turning a key) energizes a solenoid and, in some motors, applies some power to the electrical motor. Energization of the solenoid moves a solenoid shaft or plunger in an axial direction. The movement of the solenoid plunger closes electrical contacts, thereby delivering full power to the electrical motor. The movement of the solenoid plunger also biases a pinion-type gear into engagement with the engine flywheel gear.

Starter motors assemblies can be either “biaxial” or“coaxial.” These terms relate to the location of the solenoid and the solenoid plunger with respect to an armature shaft of the electrical motor. In a biaxial starter motor, the solenoid and the solenoid plunger are typically attached to the motor casing, with the solenoid plunger spaced away from and generally parallel to the armature shaft. In a coaxial starter motor, the solenoid is typically placed in the motor casing so that the solenoid plunger is aligned in the same axis with the armature shaft. The coaxial assembly is considered to be more compact and universally adaptable than the biaxial assembly. The present invention may be utilized with either a coaxial assembly or a biaxial assembly.

The closing of the electrical contacts in a starter motor assembly applies an electrical current from the battery to the electric motor. The motor's armature shaft subsequently rotates at a high speed. A planetary gear assembly, coupled to the armature shaft, reduces the speed of rotation of the armature shaft. The planetary gear assembly includes a drive shaft that rotates at that reduced speed. The end of the drive shaft opposite the planetary gear assembly is coupled with a pinion, preferably by a pinion shaft. Thus, the pinion rotates due to the rotation of the drive shaft of the planetary gear, which in turn rotates (again, at a reduced speed) due to the rotation of the armature shaft.

Energization of the solenoid also moves the solenoid plunger in an axial direction to bias the pinion into engagement with the engine flywheel gear. The plunger is coupled with the pinion such that the movement of the plunger in turn biases the pinion in an axial direction. In a coaxial assembly, the pinion is aligned in the same axis with the solenoid plunger such that the pinion is biased in the same axial direction that the plunger is biased. In a biaxial assembly, typically a lever is utilized to couple the plunger with the pinion such that the pinion is biased in the opposite axial direction that the plunger is biased. More particularly, a first end of the lever is coupled with the plunger and a second opposite end of the lever is coupled with the pinion. The biasing action of the plunger against the first end of the lever biases the first end of the lever in an axial direction so that the lever rotates in a clockwise or counter-clockwise direction. This rotational movement causes the second end of the lever to bias the pinion in the opposite axial direction from that of the plunger.

The pinion typically includes a plurality of teeth or splines on its external surface for engagement with the engine flywheel gear, which also includes teeth or splines to engage with the pinion splines. Thus, when the pinion is biased toward engagement of the flywheel and is rotating, the engagement of the pinion with the flywheel in turn causes the flywheel to rotate, thereby cranking the vehicle engine.

Once the vehicle engine is started, the operator of the vehicle then will open the ignition switch, which deenergizes the solenoid assembly. As a result of this deenergization, the magnetic field that caused the plunger to move decreases and at some point is overcome by a return spring. In particular, the return spring continually biases the pinion away from engagement with the engine flywheel. However, it is only at those times when the force of the return spring is greater than the magnetic field generated by the solenoid biasing the plunger toward the flywheel that the pinion is biased away from engagement from the flywheel.

For the energization of the solenoid assembly to move the solenoid plunger and hold the plunger for pinion-flywheel engagement, solenoid assemblies typically utilize two coils, a pull-in coil and a hold-in coil. In particular, both coils energize the plunger of the solenoid assembly to bias the plunger in the axial direction for engagement with the engine flywheel. The hold-in coil then holds the plunger in place to hold the pinion in the engagement position with the flywheel.

Conventional solenoid assemblies typically utilize a single pull-in coil and a single hold-in coil. As shown in FIG. 1, a conventional solenoid assembly includes a solenoid coil holder 118, in which a single pull-in coil 122 is formed of a single, continuous wire coiled and looped up and down the length L of holder 118. The pull-in coil 122 is shown having four layers 200, 202, 204, and 206 of increasingly greater diameter. The pull-in coil 122 is also shown being looped twice within the length L of the holder 118. In other words, the wire comprising the pull-in coil is wound down the length L to form layer 200, then is wound back up the length L to form layer 202, then is wound back down the length L to form layer 204, and finally wound back up the length L to form layer 206. Similarly, a single hold-in coil 124 is coiled and looped up and down the length L of holder 118 to form layers 230 and 232.

FIGS. 2 through 4 are circuit diagrams illustrating the sequence of starting a starter motor including the conventional single pull-in coil in the solenoid assembly. As shown, the electrical circuit 10 of the starter motor includes an ignition switch 12, a battery 14, a motor 30, and a solenoid assembly 100. In particular, the solenoid assembly 100 includes a pull-in coil 122, a hold-in coil 124, and a plunger 113.

FIG. 2 illustrates that point in time before ignition switch 12 is closed. At this point in time, coils 122,124 are not energized, no electrical current is traveling through motor 30, and plunger 113 is not magnetized and, thus, not biased in an axial direction.

FIG. 3 illustrates that point in time when ignition switch 12 is closed, thereby energizing pull-in coil 122 and hold-in coil 124. Energization of coils 122, 124 in turn biases plunger 113 to move in an axial direction to effect the closing of a plunger contact 142 and two fixed contacts 144 between battery 14 and motor 30 to deliver full power to motor 30 from battery 14. Typically, plunger contact 142 is a copper washer and fixed contacts 44 are the heads of copper bolts.

FIG. 4 illustrates that point in time when plunger 113 is biased in the axial direction sufficiently to close contacts 142,144 between battery 14 and motor 30, thereby delivering full power to motor 30 from battery 14. Once plunger 113 closes the contacts 142, 144, pull-in coil 122 is bypassed or short-circuited as shown in FIG. 4.

The pull-in coil and the hold-in coil are typically made of insulated wound wire, wrapped in a coil shape. The pull-in coil is generally an intermittent-duty coil, which is generally energized only for that period of time that it takes for the solenoid plunger to be biased in the axial direction to a seated position for pinion-flywheel engagement. Therefore, the pull-in coil is typically a high magnetomotive force, high heating coil. On the other hand, the hold-in coil is generally a continuous-duty coil, which is generally energized for the entire time that the ignition switch is closed in order to hold the plunger for pinion-flywheel engagement. Therefore, the hold-in coil is typically a low magnetomotive force, low heating coil.

The magnetomotive force of the two coils add together to pull the plunger at large air gaps, when the reluctance of the magnetic circuit is highest. During the hold-in phase (i.e., during cranking of the engine), the air gap in the magnetic circuit is very small. Therefore, the reluctance of the magnetic circuit is low, and only a relatively small magnetomotive force is required to hold the plunger for pinion-flywheel engagement. Because only a small magnetomotive force is required to hold the plunger for pinion-flywheel engagement, unwanted heating from the pull-in coil is eliminated by short circuiting this coil when the contacts close to start the motor, as discussed above.

In certain motors, motor 30 does not start until contacts 142, 144 close. In other motors, motor 30 starts before contacts 142, 144 close. For these latter motors, FIG. 3 illustrates that pull-in coil 122 is grounded through motor 30 such that, after ignition switch 12 is closed but before contacts 142, 144 close, any current flowing through pull-in coil 122 (I₁) is equal to the current flowing through motor 30 (Iₘ). If the resistance of pull-in coil 122 is low enough, then the current flowing through motor 30 (Iₘ) will be large enough to cause motor 30 to “soft start,” thereby providing a rotation of the armature shaft (not shown) of motor 30 that is sufficient to overcome friction and turn the pinion (also not shown). These motors make use of this “soft start” to engage the pinion with the engine flywheel gear. When the solenoid plunger forces the pinion in the axial direction towards engagement with the engine flywheel gear, a tooth on the pinion may hit a tooth on the flywheel gear and fail to engage. In these motors, there is typically a rigid connection between the solenoid plunger and the pinion. Thus, if the pinion stops moving, then the plunger will stop moving. Therefore, if the pinion teeth fail to engage with the flywheel gear teeth, then the plunger is prevented from being biased in the axial direction to close contacts 142, 144 to deliver full power to motor 30. However, if the current flowing through motor 30 (Iₘ) is large enough, i.e., if the resistance of pull-in coil 122 is low enough, then there will be sufficient motor torque for the pinion teeth to clear the abutment and engage with the engine flywheel gear teeth, thereby allowing closure of contacts 142, 144 to deliver full power to motor 30.

In motors that “soft start,” pull-in coil 122 generally must be comprised of a large diameter wire to have low resistance to allow sufficient current to motor 30, which again is in series with pull-in coil 122, to clear the tooth abutment between pinion and flywheel gear to close contacts 142, 144 to deliver full power to electric motor 30. The pull-in coil in motors that “soft start” generally comprises a single wire of a large diameter, typically on the order of 2.2 millimeters.

However, pull-in coils that have large diameters suffer several disadvantages. One disadvantage is that the large diameter wire is difficult to wind into a coil shape. In particular, the diameter of the wire is often beyond the limits of most conventional winding equipment, and the wire has a strong tendency to spring back from its wound shape. Also, large bend radii are required for large diameter solenoid lead wires. This fact, along with the tendency of the wire to spring back from its wound shape, makes it difficult to make sharp turns when routing the wires to their termination points.

Another disadvantage is that, when wound, there are large air gaps between the coils of the wound wire, which results in less efficient heat transfer and may increase the size of the pinion housing of the starter motor assembly.

### SUMMARY OF THE INVENTION

The present invention is directed to a solenoid assembly for a starter motor assembly including a plurality of individual coils connected in parallel to form a pull-in coil. In one embodiment, the plurality of coils comprises three coils. The plurality of coils are formed from a single wire cut and connected to form the pull-in coil. In addition, after the single wire is cut, each of the coils has a first lead and a second lead, and the first leads of each coil are connected together and the second leads of each coil are connected together. In one embodiment, the single wire is about 1.0 millimeters to about 1.5 millimeters in diameter.

The present invention is also directed to a solenoid assembly for a starter motor assembly including a pull-in coil comprised of three individual coils connected in parallel. The three individuals coils are formed from a single wire cut at two points and then connected to form the pull-in coil. After the wire is cut at two points, each of the three coils has a first lead and a second lead, and the three individual coils are connected to form the pull-in coil by connecting the first leads of each coil together and connecting the second leads of each coil together. In one embodiment, the single wire is about 1.0 millimeters to about 1.5 millimeters in diameter.

The present invention is also directed to a pull-in coil for a solenoid assembly for a starter motor assembly comprising multiple coils connected in parallel. The pull-in coil may be comprised of three coils. The three coils are formed from a single wire that is cut at two points to form the three coils. After the wire is cut at two points, each of the three coils has a first lead and a second lead, and the first leads of each coil are connected together and the second leads of each coil are connected together.

The present invention is also directed to a method of making a pull-in coil for a solenoid assembly for a starter motor assembly comprised of the following steps. First, a wire is wound down a length of a solenoid coil holder and then back up the length of the solenoid coil holder a plurality of times. Then, the wire is cut at points to form separate coils, each coil then having a first lead and a second lead opposite the first lead. Then, the first leads of the coils are electrically connected together and the second leads of the coils are electrically connected together to form the pull-in coil. The wire may be wound down and back up the length of the solenoid coil holder three times and, if so, the wire is cut at two points. In one embodiment, the wire is about 1.0 millimeters to about 1.5 millimeters in diameter.

In one embodiment, the leads are electrically connected together by tying the first leads together and tying the second leads together. In an alternative embodiment, the leads are electrically connected together by twisting the first leads together and twisting the second leads together. In another alternative embodiment, the leads are electrically connected together by soldering the first leads together and soldering the second leads together. In another alternative embodiment, the leads are electrically connected together by crimping the first leads together and crimping the second leads together.

The present invention is also directed to a method of making a pull-in coil for a solenoid assembly for a starter motor assembly comprised of the following steps. First, a wire is wound down a length of a solenoid coil holder and then back up the length of the solenoid coil holder three times. Then, the wire is cut at two points to form separate coils, each coil then having a first lead and a second lead opposite the first lead. Then, the first leads of the coils are electrically connected together and the second leads of the coils are electrically connected together to form the pull-in coil. In one embodiment, the wire is about 1.0 millimeters to about 1.5 millimeters in diameter. The leads may be electrically connected together as discussed above.

The present invention is also directed to a method of making a pull-in coil comprised of multiple coils connected in parallel for a solenoid assembly for a starter motor assembly comprised of the following steps. First, a solenoid coil holder is provided that has a first side and a second side opposite the first side. The first and second sides define a length of the solenoid coil holder. Then, a wire is wound down the length of the solenoid coil holder beginning at the first side of the solenoid coil holder and then back up the length of the solenoid coil holder ending at the first side of the solenoid coil holder. The wire is wound down and back up the length of the solenoid coil holder at least three times. Then, the wire is cut at at least two points to form separate coils. Each coil then has a first lead and a second lead opposite the first lead. Then, the first leads of the coils are electrically connected together and the second leads of the coils are electrically connected together to form the pull-in coil.

The present invention is also directed to a method of making a pull-in coil comprised of multiple coils connected in parallel for a solenoid assembly for a starter motor assembly comprised of the following steps. First, a solenoid coil holder is provided that has a first side and a second side opposite the first side. The first and second sides define a length of the solenoid coil holder. Then, a wire is wound down the length of the solenoid coil holder beginning at the first side of the solenoid coil holder and then back up the length of the solenoid coil holder ending at the first side of the solenoid coil holder. Then, the wire is looped outside the solenoid coil holder to form a first loop outside the solenoid coil holder. Next, the wire is wound down and back up the length of the solenoid coil holder a second time. Then, the wire is looped outside the solenoid coil holder a second time to form a second loop outside the solenoid coil holder. Next, the wire is wound down and back up the length of the solenoid coil holder a third time. Then, the wire is cut at two points, with one point being along the first loop and the second point being along the second loop. This forms separate coils, each coil then having a first lead and a second lead opposite the first lead. Then, the first leads of the coils are electrically connected together and the second leads of the coils are electrically connected together to form the pull-in coil. In one embodiment, the wire is about 1.0 millimeters to about 1.5 millimeters in diameter. The leads of the coils may be electrically connected together as discussed above.

The advantages of the invention will be set forth in the description below, and in part will be apparent from the description, or may be learned by practice of the invention. The advantages of the invention may be realized and obtained by the combinations set forth in the attached claims.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a cross-sectional view of the windings of a single pull-in coil and a single hold-in coil for a conventional solenoid assembly;

FIGS. 2 through 4 are circuit diagrams for the sequence of starting a conventional starter motor assembly including a single pull-in coil:

FIGS. 5 through 7 are circuit diagrams for the sequence of starting a starter motor assembly of the present invention including a pull-in coil comprised of three parallel coils;

FIGS. 8 through 11 are sequential side views of the method of making one embodiment of a solenoid assembly of the present invention including a pull-in coil comprised of three parallel coils in a solenoid coil holder; and

FIG. 12 is a side view of one half of the solenoid coil holder illustrated in FIG. 11, also including a single hold-in coil.

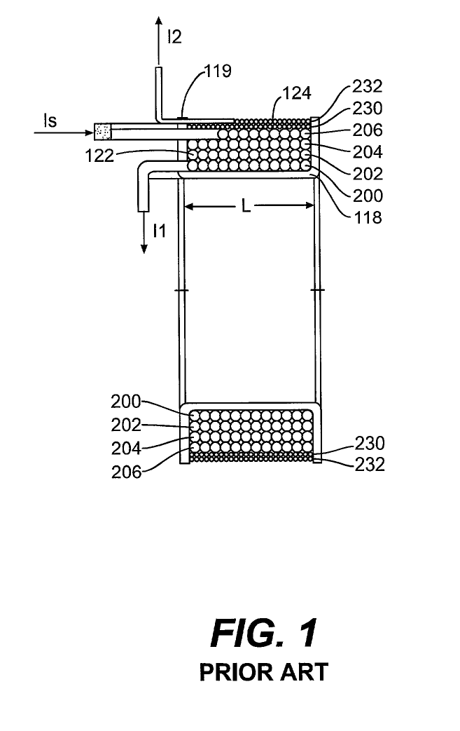

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

This description will not focus on the particular aspects of utilizing a starter motor to energize a solenoid assembly to (1) start an electrical motor to turn a pinion and (2) bias the pinion into engagement with a engine flywheel to crank the engine. These aspects were discussed above and, to the extent not discussed above, are known in the art. Instead, the focus is on the particulars of the present invention, namely, a starter motor assembly having a solenoid assembly having a pull-in coil comprised of multiple coils in parallel.

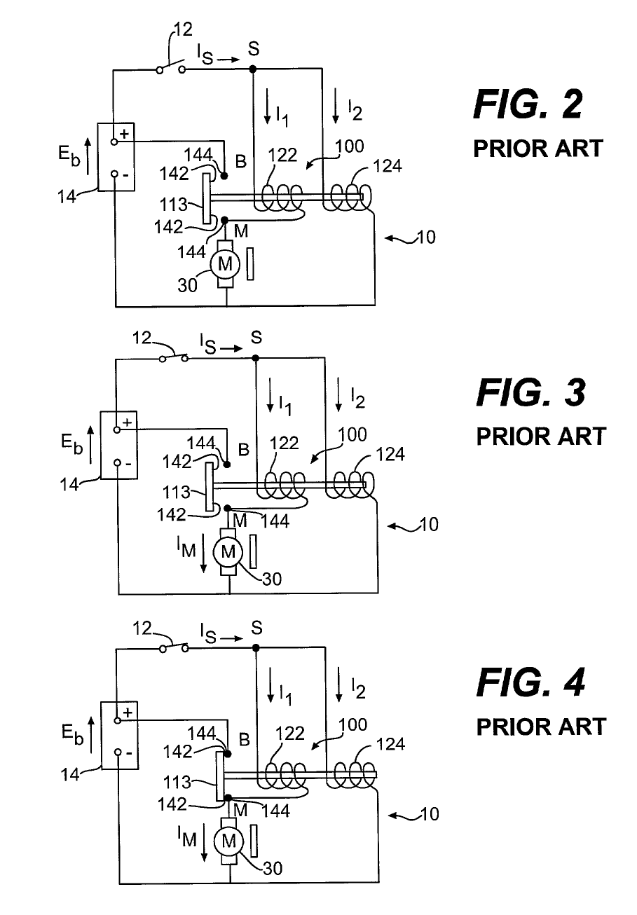

The present invention is directed to a solenoid pull-in coil which is comprised of a plurality of individual smaller diameter wires formed as a plurality of coils electrically connected in parallel, rather than a single pull-in coil comprised of a large diameter wire coil. The conventional single large diameter wire pull-in coil is discussed above and is shown schematically in FIG. I and by sequential circuit diagrams in FIGS. 2-4.

In one embodiment of the present invention, the pull-in coil includes three separate coils connected in parallel. The pull-in coil, however, is not limited to three parallel coils, but may comprise any number of parallel coils. For sake of convenience, however, a pull-in coil comprised of three separate coils will be discussed. Furthermore, the pull-in coil of the present invention is not limited to any specific type of starter motor assembly, such as a biaxial assembly, a coaxial assembly, or any other configuration.

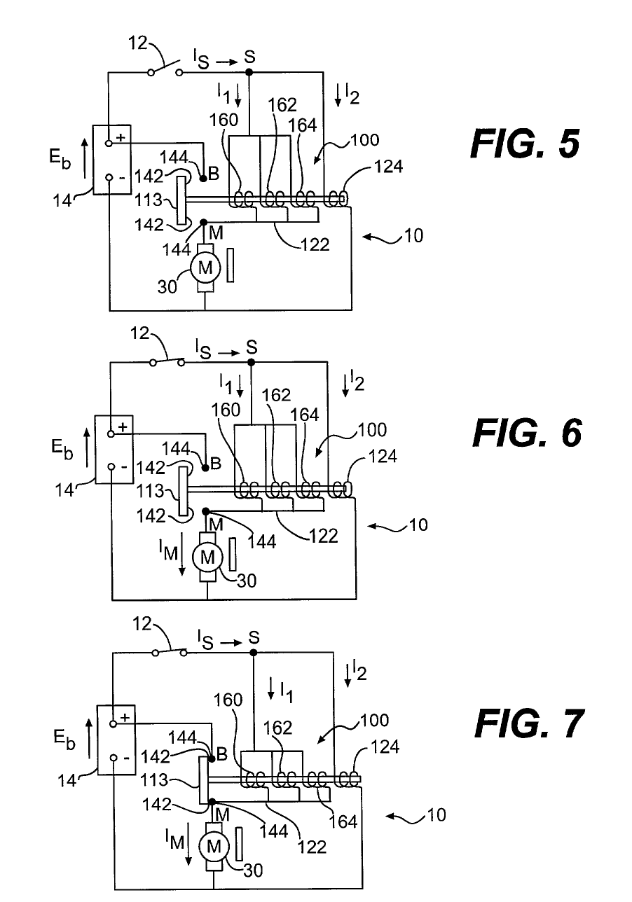

FIGS. 5-7 illustrate circuit diagrams for the sequence of starting a starter motor assembly of the present invention utilizing three coils for the pull-in coil of the starter motor assembly. As shown in FIGS. 5-7, the electrical circuit 10 of the starter motor includes ignition switch 12, battery 14, motor 30, and solenoid assembly 100, including pull-in coil 122 comprised of three coils 160, 162, and 164, hold-in coil 124, and plunger 113.

FIG. 5 illustrates that point in time before ignition switch 12 is closed. At this point in time, coils 160, 162, and 164 of pull-in coil 122, as well as hold-in coil 124, are not energized, no electrical current is traveling through motor 30, and plunger 113 is not magnetized and, thus, not biased in an axial direction. FIG. 6 illustrates that point in time when ignition switch 12 is closed, thereby energizing coils 160, 162, and 164 of pull-in coil 122, as well as hold-in coil 124, and, in some motors, delivering some current to motor 30. Energization of coils 160, 162, and 164 of pull-in coil 122 and hold-in coil 124 in turn bias plunger 113 to move in an axial direction to effect the closing of contacts 142, 144 between battery 14 and motor 30 to start or deliver full power motor 30. FIG. 7 illustrates that point in time when plunger 113 is biased in the axial direction sufficiently to close contacts 142,144 between battery 14 and motor 30, thereby delivering full power to motor 30. As shown in FIGS. 5-7, each of the coils 160, 162, and 164 of pull-in coil 122 is grounded through motor 30. Once plunger 113 closes contacts 142, 144, each of the coils 160, 162, and 164 of pull-in coil 122 is bypassed or short-circuited.

In a preferred embodiment, the group of coils for the parallel pull-in coil of the present invention is substantially equivalent to the single conventional coil the parallel coils replace in terms of electrical, magnetic, and thermal performances. The following equations may be utilized to determine equivalent resistance, equivalent field strength, and equivalent heat loss between the conventional single pull-in coil and the pull-in coil of the present invention which comprises a plurality of windings:

$$Equation 1 : Equivalent Resistance : \\ \frac{1}{{R}_{1}} = \frac{1}{{R}_{a}} + \frac{1}{{R}_{b}} + \frac{1}{{R}_{c}}$$

Equation 2: Equivalent Field Strength:

N₁I₁=NₐIₐ+N_{b}I_{b}+N_{c}I_{c}

Equation 3: Equivalent Heat Loss:

I₁²R₁=Iₐ²Rₐ+I_{b}²R_{b}+I_{c}²R_{c}

where:

“1” denotes the conventional single pull-in coil

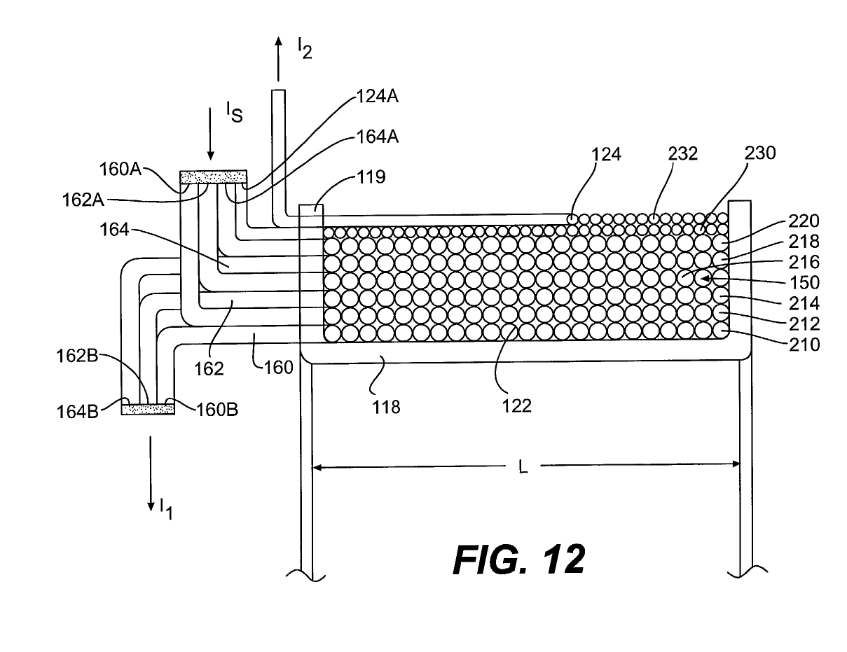

“a” denotes the innermost coil (coil 160 (see FIG. 12))

“b” denotes the middle coil (coil 162 (see FIG. 12))

“c” denotes the outermost coil (coil 164 (see FIG. 12))

R₁=Resistance of the conventional single pull-in coil

Rₐ=Resistance of the innermost coil of the three coils of the pull-in coil of the present invention

R_{b}=Resistance of the middle coil of the three coils of the pull-in coil of the present invention

R_{c}=Resistance of the outermost coil of the three coils of the pull-in coil of the present invention

N₁=Number of turns of the conventional single pull-in coil

Nₐ=Number of turns of the innermost coil of the three coils of the pull-in coil of the present invention

N_{b}=Number of turns of the middle coil of the three coils of the pull-in coil of the present invention

N_{c}=Number of turns of the outermost coil of the three coils of the pull-in coil of the present invention

I₁=Current through the conventional single pull-in coil

Iₐ=Current through the innermost coil of the three coils of the pull-in coil of the present invention

I_{b}=Current through the middle coil of the three coils of the pull-in coil of the present invention

I_{c}=Current through the outermost coil of the three coils of the pull-in coil of the present invention

If the number of turns of each of the three coils of the present invention is the same as the number of turns of the single coil of the conventional pull-in coil (i.e., Nₐ=N_{b}=N_{c}=N₁), then Equation 2 above becomes:

Equation 2:

N₁I₁=N₁(Iₐ+I_{b}+I_{c})

which in turn becomes

I₁=Iₐ+I_{b}+I_{c},

which is automatically satisfied if Equation 1 is satisfied.

In addition, with equivalent resistance between the three coils of the present invention and the conventional single coil pull-in coil, it follows that the voltage drop (Vₛₘ) across the three parallel coils of the pull-in coil of the present invention and the conventional single coil pull-in coil will be the same. Therefore, the heat loss over both the present invention and the conventional pull-in coil will be equal, as required by Equation 3, because the following Equation 4 will be true if Equation 1 is true:

$$Equation 4 : \\ {q}_{1} = \frac{{( {V}_{sm} )}^{2}}{{R}_{1}} = \frac{{( {V}_{sm} )}^{2}}{{R}_{a}} + \frac{{( {V}_{sm} )}^{2}}{{R}_{b}} + \frac{{( {V}_{sm} )}^{2}}{{R}_{c}}$$

If all of the parallel coils have the same number of turns and wire size, the resistance will not be equal because of the increasing mean diameter of each winding, i.e., R_{c}>R_{b}>Rₐ. Thus, the current through each coil will not be the same, but will be Iₐ>I_{b}>I_{c}. For critical applications where high transient currents are possible, it may be important to maintain the same current density in the parallel coils of the pull-in coil of the present invention.

$$Equation 5 : \\ J = \frac{I}{{A}_{w}} ,$$

where

J=current density in the wire

A_{w}=cross-sectional area of the wire and, again,

“a” denotes the innermost coil

“b” denotes the middle coil

“c” denotes the outermost coil

Then, if (A_{w})ₐ=(A_{w})_{b}=(A_{w})_{c}=(approx.) (A_{w})₁,/3

Then Jₐ>J_{b}>J_{c}, which means that the highest transient heating will occur in the innermost coil. Normally, the differences in current density are not significant and may be ignored. This allows the use of an uninterrupted winding of one wire size that may be cut and reconnected to form the parallel coils as discussed in more detail below. If it desired to balance the current density throughout the parallel coils, then wire sizes and/or the number of turns may be adjusted. For unequal wire diameters, the uninterrupted method of winding may not be utilized because different wires would be utilized.

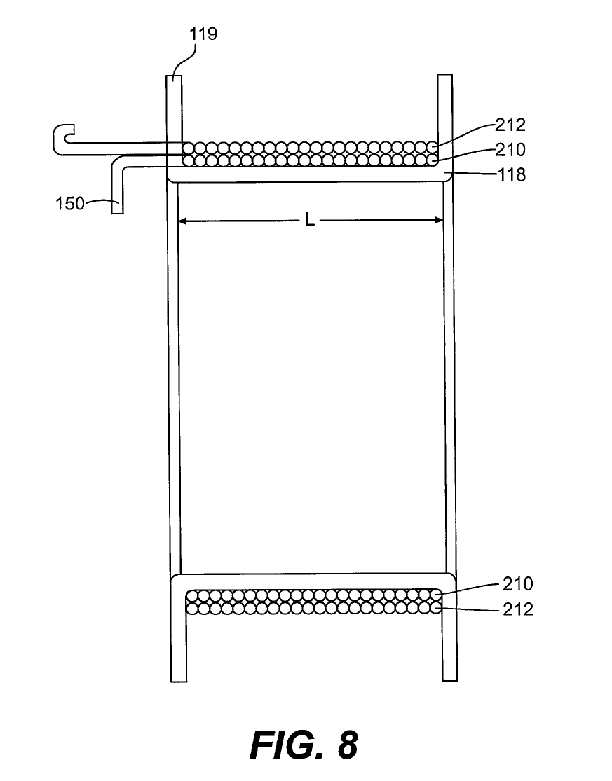

FIGS. 8-11 illustrate one method of winding a single wire to form a pull-in coil comprised of three parallel coils, while FIG. 12 illustrates one half of a solenoid coil holder having a single coil for the hold-in coil and three parallel coils for the pull-in coil. Preferably, the coils of pull-in coil are comprised of the same wire, yet are formed in such a manner to form the parallel electrical circuit. In particular, each coil is initially wound in series with the other coils. However, after each coil is wound, a programmable winder creates a loop of wire at the end of a bobbin outside of the solenoid coil holder before continuing to wind the next coil. This allows for an uninterrupted winding process of the wire that will form the three coils of the pull-in coil of the present invention. After all of the coils are wound, the loops are then cut, and the leads of the wires are connected to form the coils in parallel. The coils should generally be laid in series, cut and then connected, and not wound simultaneously. In particular, if the parallel coils are wound simultaneously, such as three wires at once, then the wires may not lay properly and a poor winding fill factor may result.

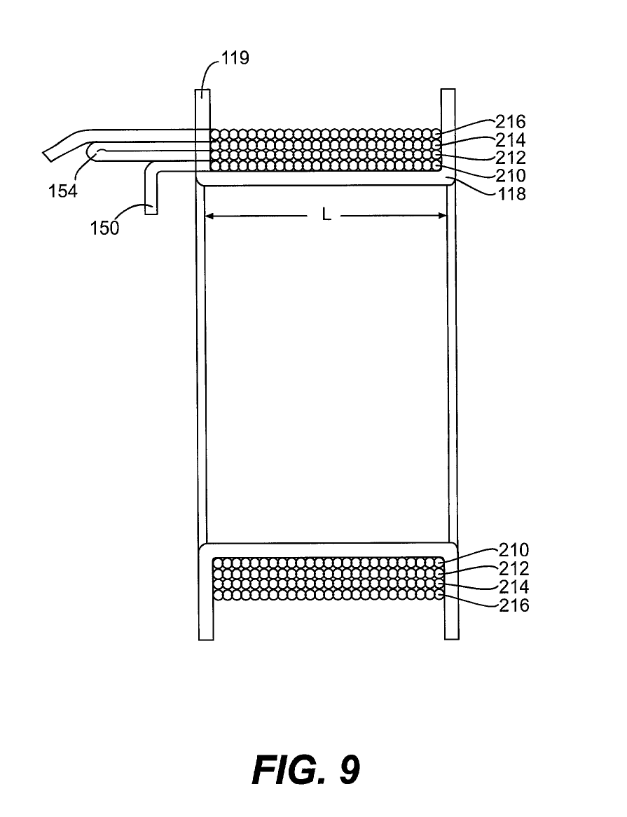

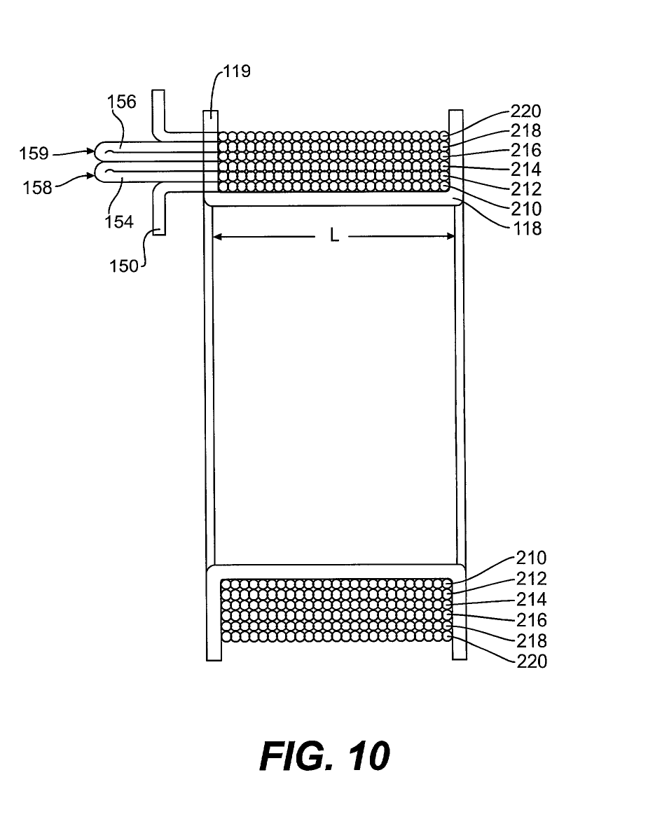

The method of making a solenoid assembly having three parallel coils for the pull-in coil will now be discussed in more detail, referring to FIGS. 8-11. As shown in FIG. 8, a single small diameter wire 150 is first wound down length L of solenoid coil holder 118 and then back up length L of solenoid coil holder 118 to the same side 119 of the solenoid coil holder 118 at which wire 150 began to be wound, thereby forming two layers 210, 212 of wire. Wire 150 is then wound down and back up the length L of solenoid coil holder 118 two more times, as shown in FIG. 9 (forming layers 214, 216) and FIG. 10 (forming layers 218, 220).

Each coil may comprise a wide variety of number of turns. Generally, each coil includes about 40 turns to about 130 turns. In one embodiment, each coil has a total of about 23 turns per layer and, thus, each coil (comprised of two layers) has about 45 turns. In addition, as discussed above, the number of coils for the parallel pull-in coil is not limited to three and may be two or more than three.

In addition, wire 150 is wound such that at side 119 of solenoid coil holder 118 where the wire winding began, wire 150 is looped around to form the second coil and then, after forming the second coil, looped around again to form the third coil. More particularly, as shown in FIG. 9, after wire 150 is wound up and down length L of coil holder 118 to form layers 210, 212, a loop 154 of wire 150 is positioned outside of coil holder 118 before winding wire 150 up and down length L of coil holder 118 a second time to form layers 214, 216. Similarly, as shown in FIG. 10, after wire 150 is wound up and down length L of coil holder 118 a second time to form layers 214, 216, a loop 156 of wire 150 is positioned outside of coil holder 118 before winding wire 150 up and down length L of coil holder a third time to form layers 218, 220.

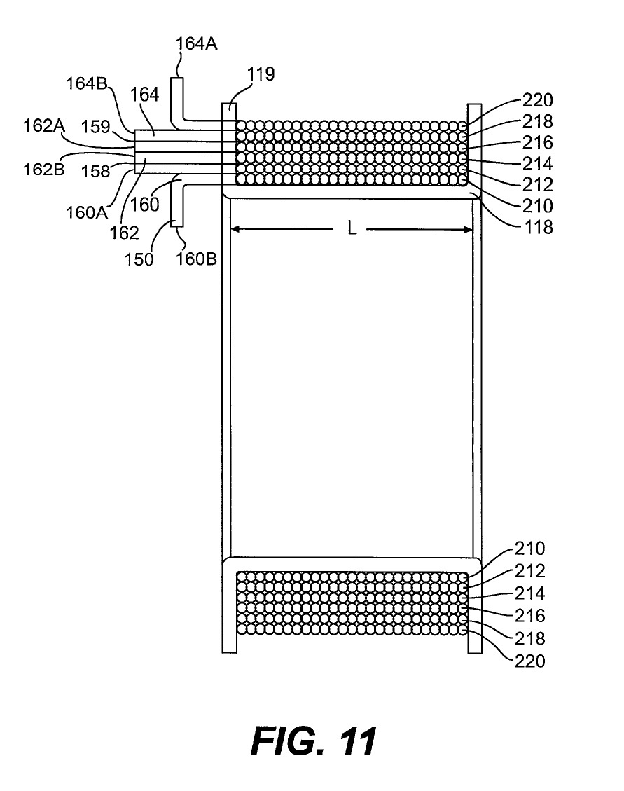

Then, after the six layers 210-220 of wire 150 are in place, wire 150 is cut at at least two places along loops 154, 156. For example, as shown in FIG. 10, wire 150 is cut at least at two points 158, 159. At that time, as shown in FIG. 11, wire 150 now comprises three separate coils 160,162, and 164. Coil 160 is generally comprised of layers 210, 212, coil 162 is generally comprised of layers 214, 216, and coil 164 is generally comprised of layers 218, 220. Each coil 160,162, and 164 has leads designated by the letter A (i.e., 160A, 162A, and 164A) and leads designated by the letter B (i.e., 160B, 162B, and 164B).

As shown in FIG. 12, in order to form the parallel coil circuit, leads 160A, 162A, and 164A of each coil are electrically connected together and leads 160B, 162B, and 164B of each coil are electrically connected together. One method of electrically connecting the leads is tying them together. Other methods may be used to electrically connect the leads, such as by twisting the leads, soldering the leads together, or crimping the leads together. Electrically connected leads 160A, 162A, and 164A may be connected to node S shown in FIGS. 5-7 to receive current 11, whereas electrically connected leads 160B, 162B, and 164B may be connected to node M in FIGS. 5-7 or vice versa.

The solenoid assembly also includes hold-in coil 124 comprised of layers 230, 232 of wire, as shown for example in FIG. 12. One lead 124A of the wire used to create coil 124 may be electrically connected to leads 160A, 162A, and 164A to receive current I₂, as shown in FIGS. 5-7.

In general, for a certain number N of parallel coil paths in the present invention, the cross-sectional area of the wire may be reduced by a factor of approximately 1/N. For example, for the above example of three parallel coils for the pull-in coil, the cross-sectional area of the wire (forming all three coils) is approximately ⅓ of the equivalent single pull-in coil design. Thus, the parallel coils of the pull-in coil of the present invention have the advantage that they may be comprised of a smaller diameter wire than a conventional single coil pull-in coil. The wire of the present invention is generally about 1.0 millimeters to 1.5 millimeters in diameter.

One advantage of a smaller diameter wire is that it is easier to wind and allows the use of conventional winding equipment. Another advantage to a smaller diameter wire is that it greatly reduces spring back after forming each layer of each coil. Another advantage is that the wire may be wound tighter, which is more efficient, having less air gaps, less heat dissipation and may result in a smaller package (i.e., smaller pinion housing for the starter motor assembly).

A further advantage of using an equivalent parallel coil group is its design flexibility. When designing any coil, attention should be given to the number of layers in the coil. For ease of manufacture and compact packaging, the beginning and end of each coil should occur on the same side of the coil holder. For optimum space utilization, this means that the number of layers per coil should be as close to an even number as possible, but not over that number. For example, with 1.9 layers in a coil, the winding moves away from the starting point for the first layer and moves back towards it in the last 0.9 layer. If a coil has 2.1 layers, however, the direction of the winding would move away from the starting side for the 0.1 layer and then the winding lead would have to be routed back over that 0.1 layer to come out on the starting side. This adds to the overall dimension of that coil and would create an uneven winding surface for the next coil to be wound (provided this coil was not the outermost coil). In solenoid design, it is typical for the value of the pull-in coil resistance to be given, as well as the available winding space. With the present invention, a different layering option results with each possible choice of the number of parallel coil paths. This improves design flexibility, resulting in a more optimized design.

Additional advantages and modifications will readily occur to those of ordinary skill in the art. The invention therefore is not limited to the specific details and embodiments shown and described above. Departures may be made from such details without departing from the spirit or scope of the invention. The scope of the invention is established by the claims and their legal equivalents.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A solenoid assembly for a starter motor assembly including a plurality of individual coils connected in parallel to form a pull-in coil.

2. The solenoid assembly of claim 1 wherein the plurality of coils comprises three coils.

3. The solenoid assembly of claim 1 wherein the plurality of coils are formed from a single wire cut and connected to form the pull-in coil.

4. The solenoid assembly of claim 3 wherein, after the single wire is cut, each of the coils has a first lead and a second lead, and wherein the first leads of each coil are connected together and the second leads of each coil are connected together.

5. The solenoid assembly of claim 3 wherein the single wire is about 1.0 millimeters to about 1.5 millimeters in diameter.

6. A solenoid assembly for a starter motor assembly including a pull-in coil comprised of three individual coils connected in parallel.

7. The solenoid assembly of claim 6 wherein the three individuals coils are formed from a single wire cut at two points and then connected to form the pull-in coil.

8. The solenoid assembly of claim 7 wherein, after the wire is cut at two points, each of the three coils has a first lead and a second lead, and wherein the three individual coils are connected to form the pull-in coil by connecting the first leads of each coil together and connecting the second leads of each coil together.

9. The solenoid assembly of claim 7 wherein the single wire is about 1.0 millimeters to about 1.5 millimeters in diameter.

10. A pull-in coil for a solenoid assembly for a starter motor assembly comprising multiple coils connected in parallel.

11. The pull-in coil of claim 10 wherein the pull-in coil is comprised of three coils.

12. The pull-in coil of claim 11 wherein the three coils are formed from a single wire that is cut at two points to form the three coils.

13. The pull-in coil of claim 12 wherein, after the wire is cut at two points, each of the three coils has a first lead and a second lead, and wherein the first leads of each coil are connected together and the second leads of each coil are connected together.

14. A method of making a pull-in coil for a solenoid assembly for a starter motor assembly comprised of the steps of:
winding a wire down a length of a solenoid coil holder and then back up the length of the solenoid coil holder a plurality of times;
cutting the wire at points to form separate coils, each coil then having a first lead and a second lead opposite the first lead; and
electrically connecting the first leads of the coils together and electrically connecting the second leads of the coils together to form the pull-in coil.

15. The method of claim 14 wherein the wire is wound down and back up the length of the solenoid coil holder three times and the wire is cut at two points.

16. The method of claim 14 wherein the wire is about 1.0 millimeters to about 1.5 millimeters in diameter.

17. The method of claim 14 wherein electrically connecting the first leads and the second leads comprises tying the first leads together and tying the second leads together.

18. The method of claim 14 wherein electrically connecting the first leads and the second leads comprises twisting the first leads together and twisting the second leads together.

19. The method of claim 14 wherein electrically connecting the first leads and the second leads comprises soldering the first leads together and soldering the second leads together.

20. The method of claim 14 wherein electrically connecting the first leads and the second leads comprises crimping the first leads together and crimping the second leads together.

21. A method of making a pull-in coil for a solenoid assembly for a starter motor assembly comprised of the steps of:
winding a wire down a length of a solenoid coil holder and then back up the length of the solenoid coil holder three times;
cutting the wire at two points to form separate coils, each coil then having a first lead and a second lead opposite the first lead; and
electrically connecting the first leads of the coils together and electrically connecting the second leads of the coils together to form the pull-in coil.

22. The method of claim 21 wherein the wire is about 1.0 millimeters to about 1.5 millimeters in diameter.

23. The method of claim 21 wherein electrically connecting the first leads and the second leads comprises tying the first leads together and tying the second leads together.

24. The method of claim 21 wherein electrically connecting the first leads and the second leads comprises twisting the first leads together and twisting the second leads together.

25. The method of claim 21 wherein electrically connecting the first leads and the second leads comprises soldering the first leads together and soldering the second leads together.

26. The method of claim 21 wherein electrically connecting the first leads and the second leads comprises crimping the first leads together and crimping the second leads together.

27. A method of making a pull-in coil comprised of multiple coils connected in parallel for a solenoid assembly for a starter motor assembly comprised of the steps of:
providing a solenoid coil holder having a first side and a second side opposite the first side, the first and second sides defining a length of the solenoid coil holder,
winding a wire down the length of the solenoid coil holder beginning at the first side of the solenoid coil holder and then back up the length of the solenoid coil holder ending at the first side of the solenoid coil holder, wherein the wire is wound down and back up the length of the solenoid coil holder at least three times;
cutting the wire at at least two points to form separate coils, each coil then having a first lead and a second lead opposite the first lead; and
electrically connecting the first leads of the coils together and electrically connecting the second leads of the coils together to form the pull-in coil.

28. A method of making a pull-in coil comprised of multiple coils connected in parallel for a solenoid assembly for a starter motor assembly comprised of the steps of:
providing a solenoid coil holder having a first side and a second side opposite the first side, the first and second sides defining a length of the solenoid coil holder,
winding a wire down the length of the solenoid coil holder beginning at the first side of the solenoid coil holder and then back up the length of the solenoid coil holder ending at the first side of the solenoid coil holder,
looping the wire outside the solenoid coil holder to form a first loop outside the solenoid coil holder,
winding the wire down and back up the length of the solenoid coil holder a second time,
looping the wire outside the solenoid coil holder a second time to form a second loop outside the solenoid coil holder,
winding the wire down and back up the length of the solenoid coil holder a third time,
cutting the wire at two points, one point being along the first loop and the second point being along the second loop, to form separate coils, each coil then having a first lead and a second lead opposite the first lead; and
electrically connecting the first leads of the coils together and electrically connecting the second leads of the coils together to form the pull-in coil.

29. The method of claim 28 wherein the wire is about 1.0 millimeters to about 1.5 millimeters in diameter.

30. The method of claim 28 wherein electrically connecting the first leads and the second leads comprises tying the first leads together and tying the second leads together.

31. The method of claim 28 wherein electrically connecting the first leads and the second leads comprises twisting the first leads together and twisting the second leads together.

32. The method of claim 28 wherein electrically connecting the first leads and the second leads comprises soldering the first leads together and soldering the second leads together.

33. The method of claim 28 wherein electrically connecting the first leads and the second leads comprises crimping the first leads together and crimping the second leads together.
